(19) United States
(12) Patent Application Publication
(10) Pub. No.: US 2016/0209976 A1
(43) Pub. Date: Jul. 21, 2016

(54) IMAGE DATA SENSING SYSTEM AND IMAGE DATA SENSING METHOD

(71) Applicant: PixArt Imaging Inc., Hsin-Chu City (TW)

(72) Inventors: Hsin-Chi Cheng, Hsin-Chu City (TW); Yu-Chia Lin, Hsin-Chu City (TW); Chun-Sheng Lin, Hsin-Chu City (TW); Jui-Te Chiu, Hsin-Chu City (TW)

(21) Appl. No.: 14/872,046

(22) Filed: Sep. 30, 2015

(30) Foreign Application Priority Data
Jan. 20, 2015 (TW) 104101856

(51) Int. Cl. G06F 3/041; G06F 1/16; G06F 3/042

(52) U.S. Cl. CPC G06F 3/0416; G06F 3/0421; G06F 1/16

(57) ABSTRACT

The present invention provides an image data sensing system comprising a controller and at least one image sensor connected in series. The controller comprises a control input port and a control output port. The controller transmits a command signal or a synchronizing signal to all image sensors via the control output port, and the image sensor transmits image data to the controller via the control input port. By this way, the number for the ports of the controller can be decreased. The present invention further provides a mechanism that the image sensor can operate at different timings if a number of the image sensor is more than one. The present invention also provides relative image sensing methods.

### BACKGROUND OF THE INVENTION

1. Field of the Invention

The present invention is related with an image data sensing system and an image data sensing method, and particularly relates to an image data sensing system and an image data sensing method which can decrease a number of control input ports, and a number of control output port of the controller.

2. Description of the Prior Art

FIG. 1 is a schematic diagram illustrating a prior art optical touch control system. As depicted in FIG. 1, the optical touch control system 100 comprises a controller 101, a touch control panel 103, a plurality of image sensors S_1-S_6, and a plurality of LED (light emitting diode) L_1-L_6. The touch control panel 103 comprises a plurality of light reflecting devices R_1-R_4. The LED L_1-L_6 emits light to the light reflecting devices R_1-R_4, thereby the light reflecting devices R_1-R_4 reflect light to the whole touch control panel 103. The image sensors S_1-S_6 catches images on the touch control panel 103. If no object, such as fingers, moves on the touch control panel 103, the image sensors S_1-S_6 captures bright images. On the contrary, if the object moves on the touch control panel 103, the object blocks light, thus some images captured by the image sensors S_1-S_6 are dark images. The image sensors S_1-S_6 transmit image data to the controller 101, which can computes a location of the object according to a relation between the bright images and the dark images.

The operation clock signal of the image sensors S_1-S_6 must be synchronized with the operation clock signal of the controller 101 to make sure the image data can be correctly transmitted and received. One method is that the controller 101 respectively provides operation clock signals to the image sensors S_1-S_6, as depicted in FIG. 1. FIG. 2 is a block diagram illustrating detail structures for a prior art controller and a prior art image sensor. As depicted in FIG. 2, the image sensor S_1 comprises an image detecting module 201, an oscillator 203 and a transceiving interface 205. The image detecting module 201 comprises a plurality of image sensing units (such as pixels) and a circuit for controlling these image sensing units. The image sensing module 201 is configured to capture an image, to convert these images to the image data IDS, and then transmits the image data IDS to the controller 201 via the transceiving interface 205. The oscillator 203 is configured to receive clock signals CLKi transmitted from the controller 101 and generates the operation clock signal CLKo based on the clock signal CLKi. The image sensing module 201 operates based on the operation clock signal CLKo, and the transceiving interface 205 transmits image data IDS to the controller 101 according to the operation clock signal CLKo. The image sensor S_1 can further comprise a frequency divider to frequency-divide the operation clock signal CLKo to generate operation clock signals with other frequencies. For example, the clock signal CLKi is 1 MHz and the operation clock signal CLKo is 48 MHz, but the transceiving interface 205 does not need an operation clock signal with such a high frequency. Accordingly, the image sensor S_1 can further comprise a frequency divider to frequency-divide the operation clock signal CLKo to generate an operation clock signal with a frequency that the transceiving interface 205 needs. Other details are known by persons skilled in the art, thus are omitted for brevity here.

However, if the structure depicted in FIG. 1 and FIG. 2 are applied, the controller 101 needs six different control output ports P_1-P_6 and corresponding transmitting lines to provide operation clock signals to image sensors S_1-S_6. For such structure, the layouts are complicated and the circuit occupies a larger region, and disobeys the tendency that a modern electronic apparatus is desired to be smaller. Also, in the structure of FIG. 1, the LED control circuit for the LEDs L1-L6 are also included in the controller 301, thus an extra port and a transmitting line are needed to transmit commands to LEDs L1-L6, thus the circuit region further increases and the difficulty for layout further increases as well. For more detail, if the controller 101 needs to communicate with the image sensor and the LED control circuit, 4 transmitting ports are needed: an input port/an output port communicating with the image sensor, and an input port/an output port communicating with the LED control circuit. The output port communicating with the image sensor is applied to transmit commands to the image sensor, and the input port communicating with the image sensor is applied to receive image data from the image sensor. Similarly, the output port communicating with the LED control circuit is applied to transmit commands to the LED control circuit, and the input port communicating with the LED control circuit is applied to receive responses from the LED control circuit. Therefore, many input port/output ports and transmitting lines are needed between the controller, the image sensor and the LED control circuit.

### SUMMARY OF THE INVENTION

Therefore, one objective of the present invention is to provide an image data sensing system and an image data sensing method which can decrease a number for the control input port, the control output port of the controller.

Another objective of the present invention is to provide an image data sensing system and an image data sensing method which provides a light emitting device control device not located in the controller.

Another objective of the present invention is to provide an image data sensing system and an image data sensing method which can control image sensors coupled in series to operate non-simultaneously.

One embodiment of the present invention provides an image data sensing system, comprising: a controller, comprising a first control input port and a first control output port, wherein the controller outputs a first command signal and a first synchronizing signal via the first control output port; and a first image sensor, comprising a first sensing input port and a first sensing output port, and comprises a first clock controller configured to control an operation clock signal for the first image sensor. The first image sensor receives the first command signal via the first sensing input port to determine if first image data is output by the first sensing output. The first clock controller adjusts the operation clock signal for the first image sensor to generate a first adjusted operation clock signal based on the first synchronizing signal received by the first sensing input port. The first image sensor outputs the first image data to the controller via the first sensing output port based on the first adjusted operation clock signal.

Another embodiment of the present invention provides an image data sensing system, which comprises: a controller, comprising a first control input port and a first control output port, and comprising a clock controller to control an operation clock signal for the controller, wherein the controller outputs a first command signal via the first control output port; and a first image sensor, comprising a first sensing input port and a first sensing output port, wherein the first image sensor receives the first command signal via the first sensing input port and generates first image data. The first image sensor determines if the first image data is output according to the first command signal. The first image sensor outputs a first synchronizing signal to the controller via the first sensing output port, wherein the controller receives the first synchronizing signal via the first control input port. The clock controller adjusts an operation clock signal for the controller according to the first synchronizing signal to generate an adjusted operation clock signal. The controller receives the first image data via the first control input port based on the adjusted operation clock signal.

Still another embodiment of the present invention provides an image data sensing system, comprising: a controller, comprising a first control input port and a first control output port, configured to output a first command signal via the first control output port; a first image sensor, comprising a first memory device, a first sensing input port and a first sensing output port, configured to receive the first command signal via the first sensing input port and to output first image data to the controller via the first control output port based on the first command signal; and a second image sensor, coupled to the first image sensor in series, comprising a second memory device, a second sensing input port and a second sensing output port, configured to receive the first command signal via the first sensing input port and to output second image data to the controller via the second control output port based on the first command signal. The first image sensor and the second image sensor determines when to operate based on the first command signal according to time information stored in the first memory device and the second memory device.

In view of above-mentioned embodiments, the controller can comprise only one control input port and only one control output port, to decrease the circuit region and to decrease the complexity for layout. Also, via a corresponding synchronizing mechanism, the image sensor can correctly output image data and the controller can correctly receive image data. Further, the mechanisms, which are provided by the present invention, for avoiding the image sensors operating simultaneously can make sure that the image sensors will not conflict to each other while transceiving signals. Furthermore, the circuit region and the complexity for layout can be decreased as well if the light emitting device control device is provided in the controller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a prior art optical touch control system.

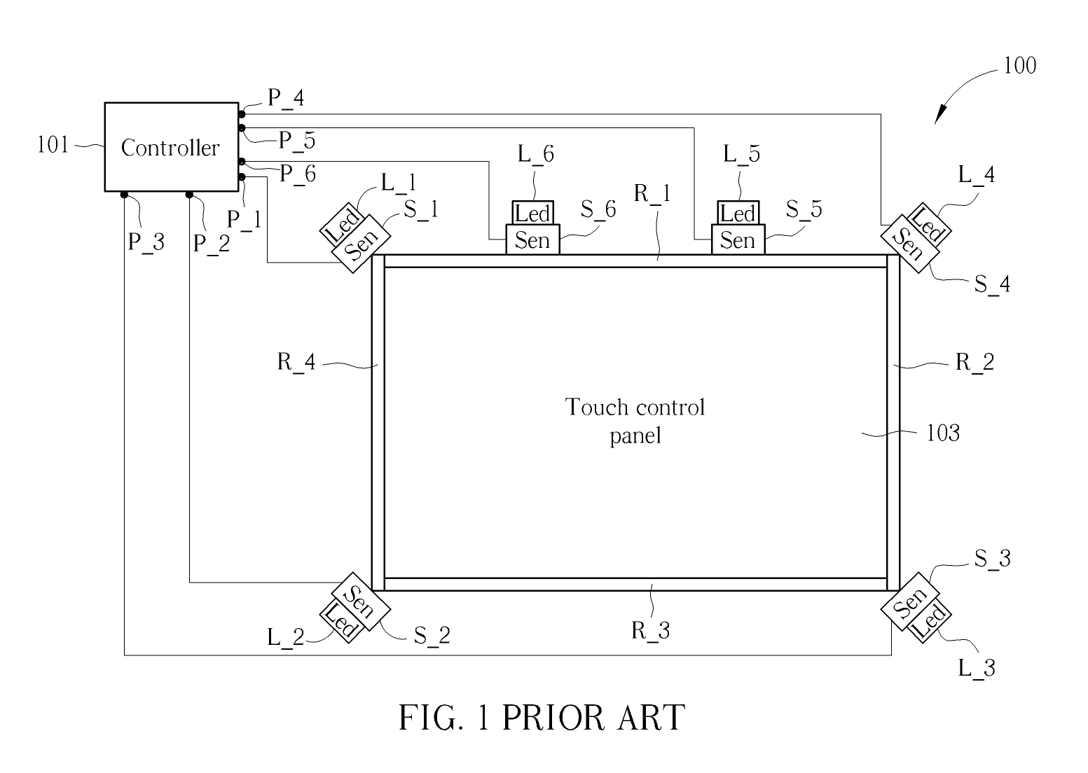

FIG. 2 is a block diagram illustrating detail structures for a prior art controller and a prior art image sensor.

FIG. 3 is a block diagram illustrating a prior art optical touch control system according to one embodiment of the present invention.

FIG. 4 is a block diagram illustrating detail circuits for a controller and an image sensor according to one embodiment of the present invention.

FIG. 5 is a schematic diagram illustrating an optical touch control system according another embodiment of the present invention.

FIG. 6 is a schematic diagram illustrating an optical touch control system according still another embodiment of the present invention.

FIG. 7 is a schematic diagram illustrating a command signal, a synchronization signal and an image data signal provided by the present invention.

FIG. 8 is a block diagram illustrating detail circuits for a controller and an image sensor according to another embodiment of the present invention.

### DETAILED DESCRIPTION

Different embodiments are applied to explain the concept of the present invention. Please note, in following embodiments, the controller comprises a control input port and a control output port, but it does not mean the control input port and the control output port are independent ports. The control input port and the control output port can be integrated to a single port. Similarly, the image sensor comprises a sensing input port and a sensing output port, but it does not mean the sensing input port and the sensing output port are independent ports. The sensing input port and the sensing output port can be integrated to a single port. In following embodiments, for the clarity of explanation, the examples that the two ports are integrated to a single port are applied for explaining.

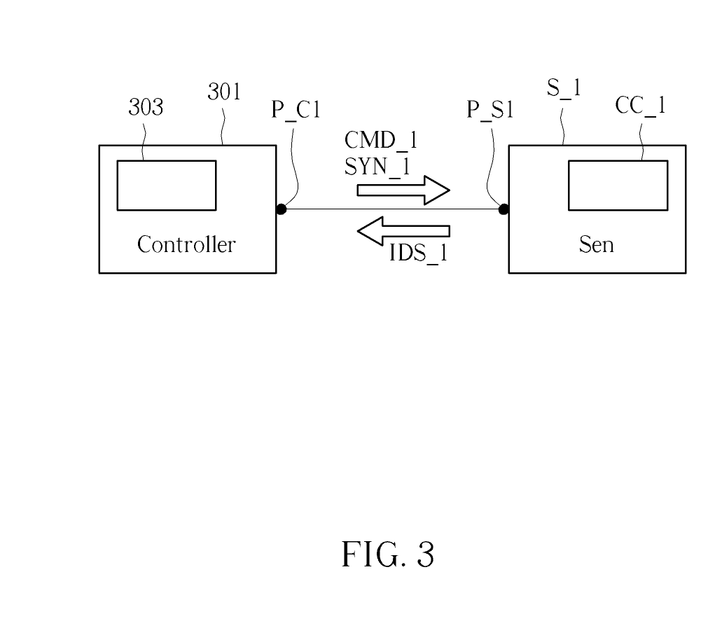

FIG. 3 is a block diagram illustrating a prior art optical touch control system according to one embodiment of the present invention. As depicted in FIG. 3, the controller 301 comprises a control input port and a control output port (both named P_C1). The image sensor S_1 comprises a sensing input port and a sensing output port (both named P_S1). Further, the image sensor S_1 comprises a clock controller CC_1 configured to control an operation clock signal for the image sensor S_1. Please note, as above-mentioned, the control input port and the control output port can be independent ports or integrated to a single port, and the sensing input port and the sensing output port can be independent ports or integrated to a single port. In the following examples, the ports are integrated to a single port. The controller 301 outputs a command signal CMD_1 and a synchronizing signal SYN_1 via the control output port P_C1. In one embodiment, all signals output by the same control output port are transmitted by a time division multiplexing method, that is, transmit non-simultaneously. The image sensor S_1 receives the command signal CMD_1 via the sensing input port P_S1 to determine if using the sensing output port P_S1 to output image data IDS_1. Besides, the clock controller CC_1 adjusts the operation clock signal for the image sensor S_1 to generate a first adjusted operation clock signal based on the synchronizing signal SYN_1 received by the sensing input port P_S1. The image sensor S_1 outputs the image data IDS_1 to the controller 301 via the sensing output port P_S1 based on the adjusted operation clock signal. Please note, the operation″ adjusts the operation clock signal for the image sensor S_1″ can mean: a new operation clock signal is generated if the image sensor S_1 does not operate, or means: generate a new operation clock signal to replace an original operation clock signal that the image sensor S_1 originally operate at. Additionally, such adjust operation can indicate adjusting the frequency of the clock and/or adjusting the edges of the operation clock signal (i.e. adjusting a phase).

In one embodiment, the controller 301 comprises a clock controller 303, to control an operation clock signal for the controller 301. Also, the controller 301 determines the synchronizing signal SYN_1 according such operation clock signal. For example, the synchronizing signal SYN_1 generated by the controller 301 is the same as the operation clock for the controller 301. In another embodiment, the controller 301 transmits the command signal CMD_1 to the image sensor S_1 only via the control output port P_C1, and transmits the synchronizing signal SYN_1 to the image sensor S_1 only via the control output port P_C1. Furthermore, the image sensor S_1 transmits image data IDS_1 to the controller 301 only via the control input port P_C1 of the controller 301.

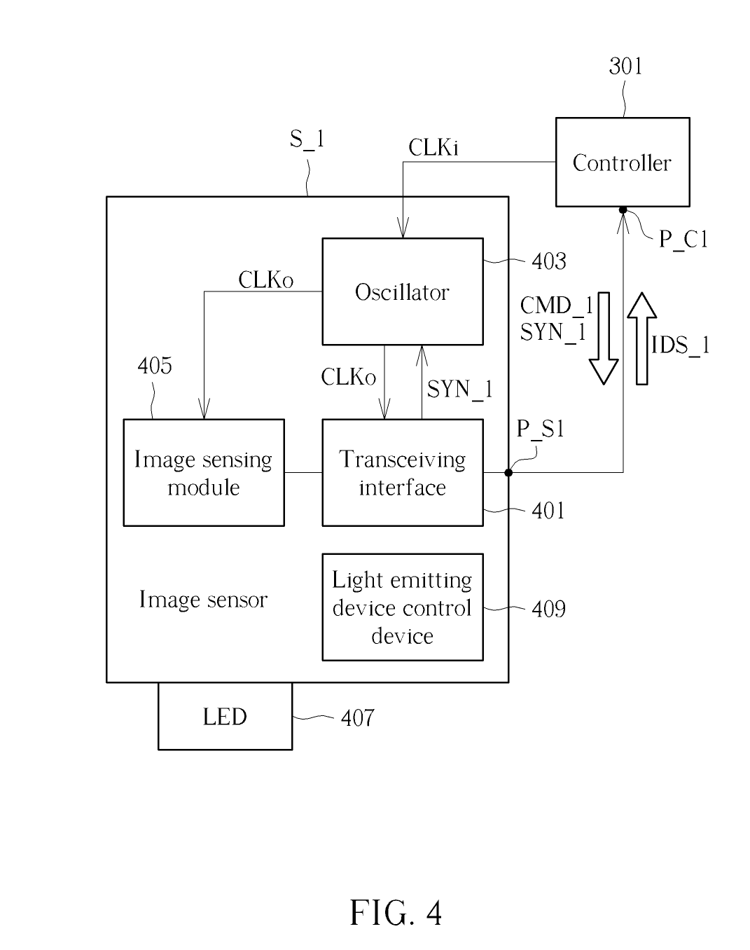

FIG. 4 is a block diagram illustrating detail circuits for a controller and an image sensor according to one embodiment of the present invention. As depicted in FIG. 4, the image sensor S_1 comprises a transceiving interface 401, an oscillator 403 (served as above-mentioned clock controller CC_1), and an image sensing module 405. The transceiving interface 401 is configured to receive/transmit data, and can be various kinds of transceiving interfaces. In one embodiment, the transceiving interface 401 is a LVDS (Low Voltage Differential Signaling) interface. In such case, the control input port/control output port P_C1 and sensing input port/sensing output port P_S1 all comprises D+ and D− lines. However, the transceiving interface 401 is not limited to the LVDS interface. The image sensing module 405 can comprise an image sensing unit and an image sensing unit control circuit, but the descriptions there are omitted for brevity here.

In one embodiment, the synchronizing signal SYN_1 is a clock signal. Also, the transceiving interface 401 transmits the synchronizing signal SYN_1 to the oscillator 403 after receives it, and then the oscillator 403 oscillates to generate a desired operation clock signal CLKo based on the synchronizing signal SYN_1. After that, the operation clock signal CLKo is transmitted to the image sensing module 405, which operates based on the operation clock signal CLKo. Additionally, the operation clock signal CLKo is transmitted to the transceiving interface 401 as well, which transmits image data IDS_1 to the controller 301 based on the operation clock signal CLKo. It should be noted that the image sensor S_1 is not limited to the embodiment in FIG. 4. For example, the image sensor S_1 can further comprises a frequency-divider to frequency-divide the operation clock signal CLKo, to generate an operation clock signal with a lower frequency to the transceiving interface 401 or the image sensing module 405. Please note, the scope of the present invention is not limited to the embodiment depicted in FIG. 4, the circuit which has the same function as which of the embodiment of FIG. 4 should fall in the scope of the present invention. For example, the image sensor S_1 can comprise a clock controller, to adjust the oscillator 403 to generate an operation clock signal after receives the synchronizing signal SYN_1.

In one embodiment, the synchronizing signal SYN_1 is a clock signal with the frequency 1M, and the operation clock signal CLKo is 48 MHz. Also, in one embodiment, the image sensor S_1 adjusts the operation clock signal thereof again, after transmits one frame to the controller 301. Additionally, in one embodiment, the optical touch control system provided by the present invention can further comprise a light emitting device 407 (in this embodiment, a LED, but not limited). Also, the light emitting device control device 409 configured to control the light emitting device 407 is also provided in the image sensor S_1. By this way, the light emitting device control device 409 can control the light emitting device 407 based on the command signal CMD_1 transmitted by the controller 301, such that the controller 301 does not need an extra port to control the light emitting device.

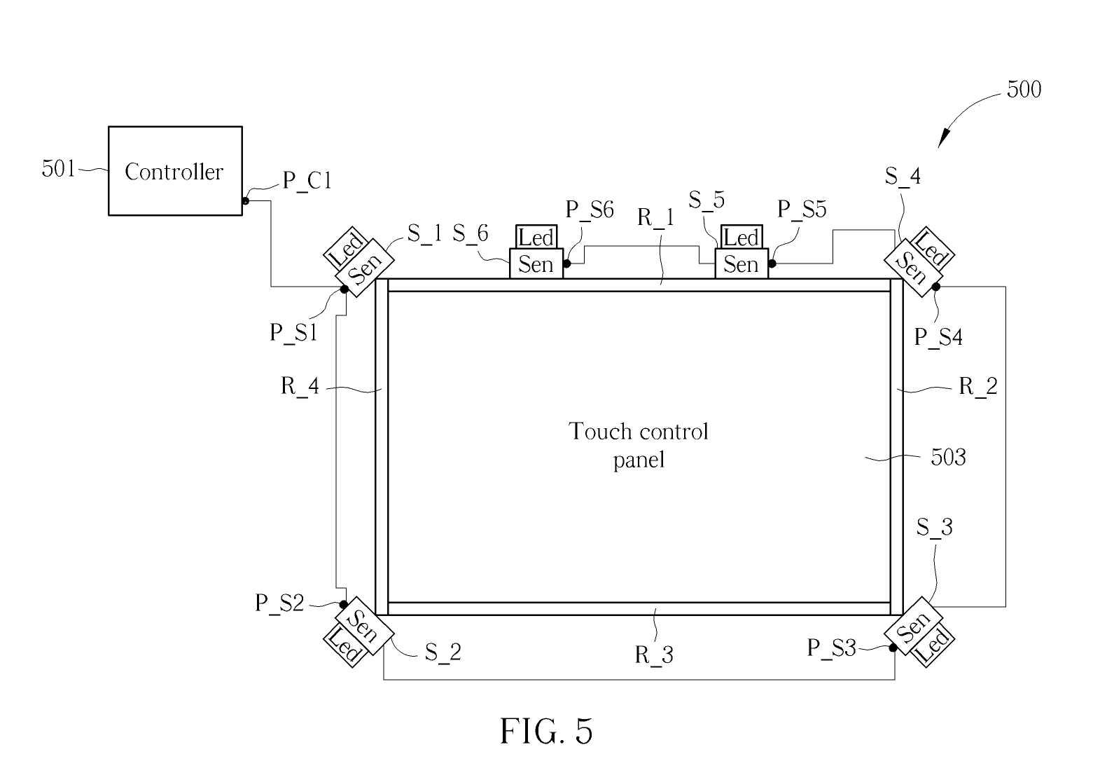

FIG. 5 is a schematic diagram illustrating an optical touch control system according another embodiment of the present invention. In the embodiment of FIG. 5, a number of the image sensors S_1-S_6 is larger than 1 and coupled in series. Each of the image sensors S_1-S_6 comprises a sensing input port and a sensing output port (P_S1-P_S6). By this way, the controller 501 can transmit the command signal and the synchronizing signal to each image sensor via the control input port/control output port P_C1. After that, the image sensor can operate based on the command signal and the synchronizing signal, as depicted in FIG. 3 and FIG. 4. Please note, the number, the locations, and the line connections of the image sensor is not limited to the embodiment depicted in FIG. 5.

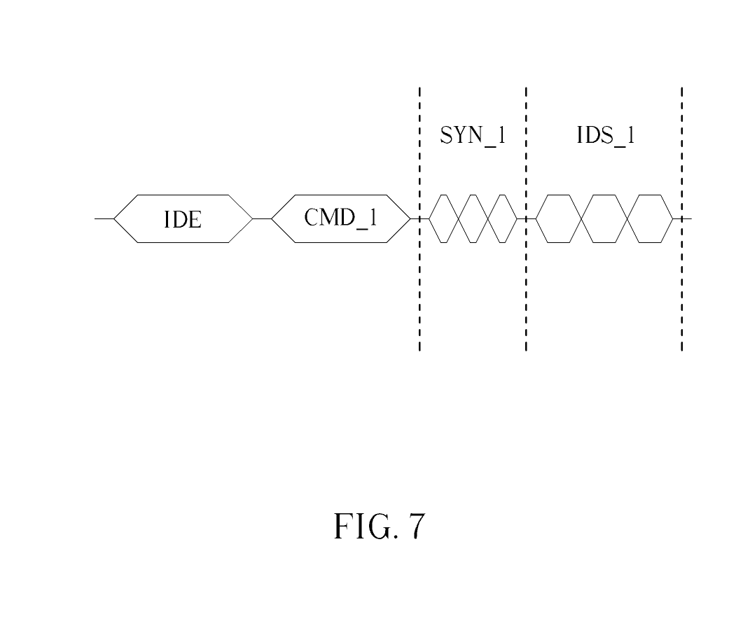

The image sensors S_1-S_6 may simultaneously operate while the controller 501 transmits a command signal to the image sensors S_1-S_6, if no protection mechanism is provided. Accordingly, the image sensors may conflict while transmitting image data. Therefore, the present invention further provides a mechanism that the image sensors S_1-S_6 do not simultaneously operate even if the image sensors S_1-S_6 receive the command at the same time. Please refer to FIG. 7, in one embodiment, the controller 501 further transmits an identifying signal IDE to each of the image sensors, for appointing which one or which ones of the image sensors should respond image data corresponding to the command signal CMD_1, before transmits the command signal CMD_1 and the synchronizing signal SYN_1. The image sensors which are not appointed will not operate. For such mechanism, the controller 501 can transmit a “common command signal” to each image sensor, which does not comprise the identifying signal, and each the image sensor starts to operate after receives the common command signal. The schematic diagram of FIG. 7 also describes the following content: the identifying signal IDE, the command signal CMD_1 and the synchronizing signal SYN_1 are combined together, and transmits the identifying signal IDE, the command signal CMD_1 and the synchronizing signal SYN_1 together via a time division multiplexing method.

In another embodiment, the image sensor respectively comprises a memory device (ex. a register), which contains time information. Each image sensor refers the time information to determine when to operate after receives the command signal. For more detail, take image sensors S_1 and S_2 for example, the image sensor S_1 comprises a memory device (not illustrated), and the image sensor S_2 comprises a memory device as well (not illustrated). The image sensor S_1 and the image sensor S_2 determine when to operate based on the command signal CMD_1 according to time information stored in the memory devices.

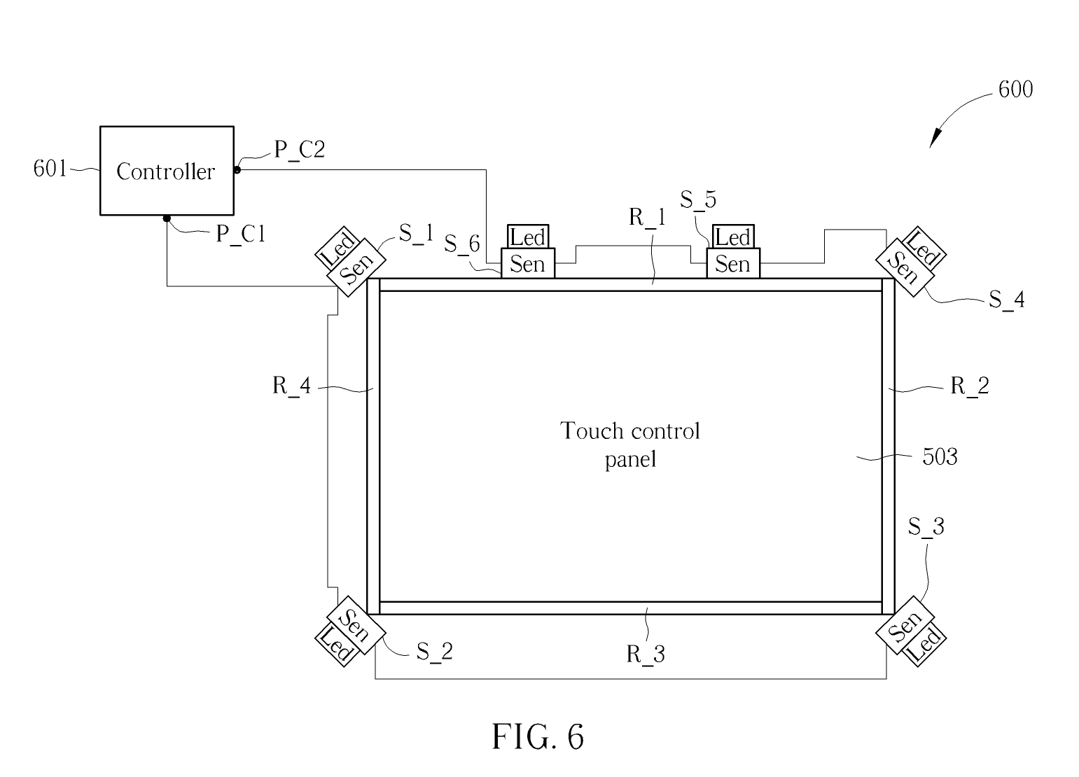

Please note, the present invention does not limit that all image sensors are coupled in series. As depicted in FIG. 6, the controller 501 further comprises a control input port/control output port P_C2 besides the control input port/control output port P_C1. The image sensors S_1, S_2 and S_3 are coupled to the control input port/control output port P_C1 in series, and the image sensors S_4, S_5 and S_6 are coupled to the control input port/control output port P_C2 in series. The operation for the embodiment of FIG. 6 is similar with the operation for other embodiments. The only difference is that the image sensors coupled in different series transceive signal, data with different control input/control output, related operation are omitted here for brevity.

The optical touch control apparatus is taken for example to explain above-mentioned embodiments. However, the above-mentioned embodiments can be applied to other electronic apparatuses which need to sense images. Accordingly, the image data sensing system provided by the present invention can be summarized as: an image data sensing system comprising: a controller (301), comprising a first control input port and a first control output port (P_C1), wherein the controller outputs a first command signal (CMD_1) and a first synchronizing signal (SYN_1) via the first control output port; and a first image sensor (S_1), comprising a first sensing input port and a first sensing output port (P_S1), and comprises a first clock controller (CC_1) configured to control an operation clock signal for the first image sensor. The first image sensor receives the first command signal via the first sensing input port to determine if first image data (IDS_1) is output by the first sensing output. The first clock controller adjusts the operation clock signal for the first image sensor to generate a first adjusted operation clock signal based on the first synchronizing signal received by the first sensing input port. The first image sensor outputs the first image data to the controller via the first sensing output port based on the first adjusted operation clock signal. Such image data sensing system corresponds to the embodiment of FIG. 3.

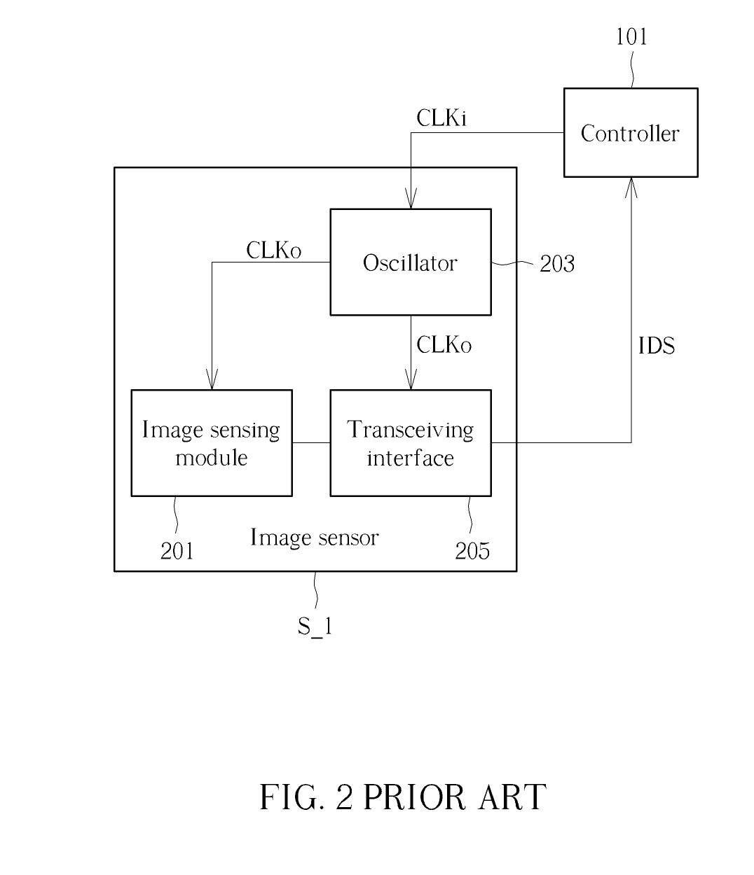

If the image data sensing system further comprises a second image sensor (ex. S_2 in FIG. 5) coupled to the first image sensor in series, the image data sensing system can be summarized as follows: a second image sensor (S_2), coupled to the first image sensor in series, comprising a second sensing input port and a second sensing output port (P_S2 in FIG. 2), and comprising a second clock controller to control an operation clock signal for the second image sensor. The second image sensor receives the first command signal via the second sensing input port to determine if second image data is output by the second sensing output port. The second clock controller adjusts the operation clock signal for the second image sensor to generate a second adjusted operation clock signal based on the first synchronizing signal received by the second sensing input port. The second image sensor outputs the second image data to the controller via the second sensing output port based on the second adjusted operation clock signal.

If the above-mentioned data sensing system further comprises another control input port, control output port (ex. P_C2 in FIG. 6), the image data sensing system can be summarized as follows: the controller further comprises a second control output port and a second control input port. The image data sensing system further comprises: a third image sensor (S_6), comprising a third sensing input port and a third sensing output port. The operation for the third image sensor is the same as which of the first image sensor, but the port for transceiving the signal becomes to the second control input port and the second control output port, thus is omitted here for brevity.

An image data sensing method corresponding to the image data sensing system shown in FIG. 3 can be acquired. The image data sensing method comprises: outputting a first command signal and a first synchronizing signal via the first control output port (P_C1); receiving the first command signal (CMD_1) via the first sensing input port P_S1 to determine if first image data is output by the first sensing output; adjusting the operation clock signal for the first image sensor (S_1) to generate a first adjusted operation clock signal based on the first synchronizing signal (SYN_1) received by the first sensing input port; and applying the first image sensor to output the first image data (IDS_1) to the controller via the first sensing output port based on the first adjusted operation clock signal. The image data sensing methods correspond to FIG. 5 and FIG. 6 can be acquired in view of above-mentioned embodiments, thus are omitted for brevity here.

The above-mentioned mechanism, which control image sensors coupled in series at different timings via the memory device, can be summarized as follows: An image data sensing system, comprising: a controller, comprising a first control input port and a first control output port, configured to output a first command signal via the first control output port; a first image sensor, comprising a first memory device, a first sensing input port and a first sensing output port, configured to receive the first command signal via the first sensing input port and to output first image data to the controller via the first control input port based on the first command signal; and a second image sensor, comprising a second memory device, a second sensing input port and a second sensing output port, configured to receive the first command signal via the first sensing input port and to output second image data to the controller via the second control input port based on the first command signal. The first image sensor and the second image sensor determines when to operate based on the first command signal according to time information stored in the first memory device and the second memory device. That is, if an image data sensing system comprises a plurality of image sensors coupled in series and controls the image sensors to operate at different timings via at least one memory device, such image data sensing system should fall in the scope of the above-mentioned image data sensing system

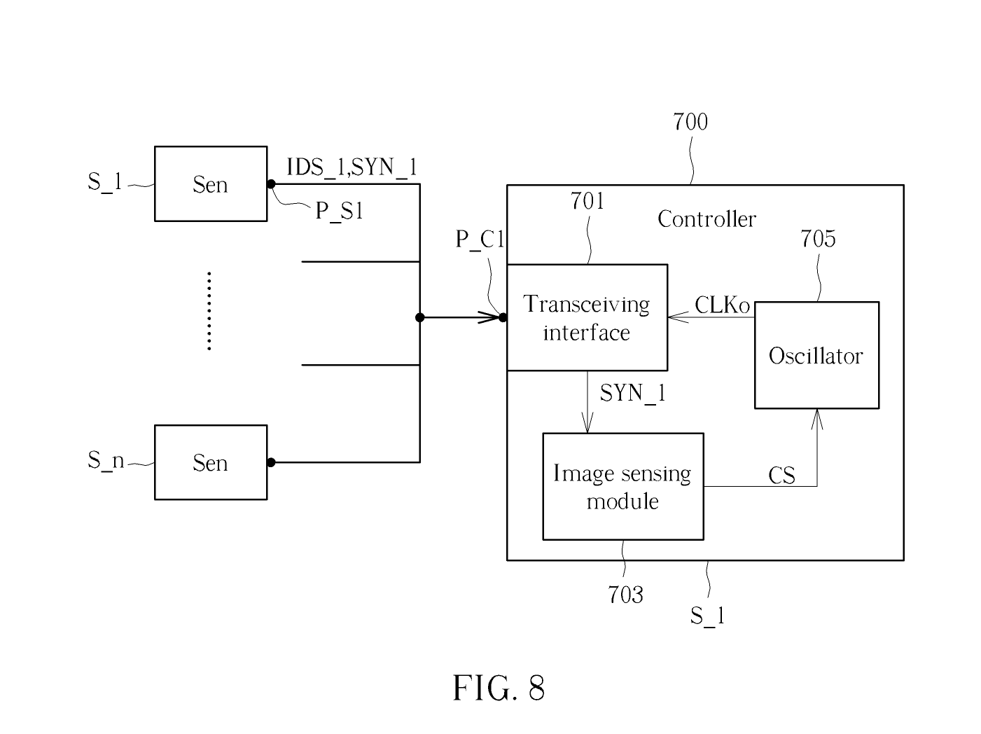

Besides applying the controller to calibrate the operation clock signal for the image sensor, the present invention also provides a mechanism which applies the image sensor to calibrate the operation clock signal for the controller. FIG. 8 is a block diagram illustrating detail circuits for a controller and an image sensor according to another embodiment of the present invention. As depicted in FIG. 8, the image sensor S_1 transmits a synchronizing signal to the controller 700 before transmits image data IDS_1 to the controller 700 based on the command signal provided by the controller 700. The clock controller 703 transmits a control signal CS to the oscillator 705 based on the synchronizing signal SYN_1. After that, the oscillator 705 generates the operation clock signal CLKo to the transceiving interface 701 according to the control signal CS. The transceiving interface 701 receives the image data IDS_1 based on the operation clock signal CLKo.

Please note, the embodiment for FIG. 8 is only for example, any circuit that has the same function as which of FIG. 8 should all fall in the scope of the present invention. Accordingly, the embodiment of FIG. 8 can be summarized as: An image data sensing system, comprising: a controller (700), comprising a first control input port and a first control output port (P_C1), and comprising a clock controller (703) to control an operation clock signal for the controller, wherein the controller outputs a first command signal via the first control output port; and a first image sensor (S_1), comprising a first sensing input port and a first sensing output port (P_S1). The first image sensor receives the first command signal via the first sensing input port and generates first image data (IDS_1). The first image sensor determines if the first image data is output according to the first command signal. The first image sensor outputs a first synchronizing signal (SYN_1) to the controller via the first sensing output port. The controller receives the first synchronizing signal via the first control input port (P_C1). The clock controller adjusts an operation clock signal for the controller according to the first synchronizing signal to generate an adjusted operation clock signal. The controller receives the first image data via the first control input port based on the adjusted operation clock signal (CLKo). Based on this image data sensing system, an image data sensing method can be acquired, the steps thereof can be acquired in view of the description of FIG. 8, thus are omitted for brevity here.

In view of above-mentioned embodiments, the controller can comprise only one control input port and only one control output port, to decrease the circuit region and to decrease the complexity for layout. Also, via a corresponding synchronizing mechanism, the image sensor can correctly output image data and the controller can correctly receive image data. Further, the mechanisms, which are provided by the present invention, for avoiding the image sensors operating simultaneously can make sure that the image sensors will not conflict to each other while transceiving signals. Furthermore, the circuit region and the complexity for layout can be decreased as well if the light emitting device control device is provided in the controller.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image data sensing system, comprising:
a controller, comprising a first control input port and a first control output port, wherein the controller outputs a first command signal and a first synchronizing signal via the first control output port; and
a first image sensor, comprising a first sensing input port and a first sensing output port, and comprises a first clock controller configured to control an operation clock signal for the first image sensor;
wherein the first image sensor receives the first command signal via the first sensing input port to determine if first image data is output by the first sensing output;
wherein the first clock controller adjusts the operation clock signal for the first image sensor to generate a first adjusted operation clock signal based on the first synchronizing signal received by the first sensing input port;
wherein the first image sensor outputs the first image data to the controller via the first sensing output port based on the first adjusted operation clock signal.

2. The image data sensing system of claim 1, wherein the controller comprises a clock controller configured to control an operation clock signal for the controller, wherein the controller determines the first synchronizing signal according to the operation clock signal for the controller.

3. The image data sensing system of claim 1, wherein the controller transmits the first command signal to the first image sensor only via the first control output port, and transmits the first synchronizing signal to the first image sensor only via the first control output port, wherein the first image sensor transmits image data to the controller only via the control input port of the controller.

4. The image data sensing system of claim 1, wherein the controller transmits the first command signal and the first synchronizing signal via a time division multiplexing method.

5. The image data sensing system of claim 1, further comprising:
a second image sensor, coupled to the first image sensor in series, comprising a second sensing input port and a second sensing output port, and comprising a second clock controller to control an operation clock signal for the second image sensor;
wherein the second image sensor receives the first command signal via the second sensing input port to determine if second image data is output by the second sensing output port;
wherein the second clock controller adjusts the operation clock signal for the second image sensor to generate a second adjusted operation clock signal based on the first synchronizing signal received by the second sensing input port;
wherein the second image sensor outputs the second image data to the controller via the second sensing output port based on the second adjusted operation clock signal.

6. The image data sensing system of claim 5, wherein the controller further transmits an identifying signal to the first image sensor and the second image sensor, for appointing which one or which ones of the first image sensor and the second image sensor should respond image data corresponding to the first command signal.

7. The image data sensing system of claim 6, wherein the controller combines the identifying signal, the command signal and the first synchronizing signal together, and transmits the identifying signal, the command signal and the first synchronizing signal together via a time division multiplexing method.

8. The image data sensing system of claim 6, wherein the first image sensor comprises a first memory device, wherein the second image sensor comprises a second memory device, wherein the first image sensor and the second image sensor determines when to operate based on the first command signal according to time information stored in the first memory device and the second memory device.

9. The image data sensing system of claim 1, wherein the controller further comprises a second control output port and a second control input port, wherein the image data sensing system further comprises:
a third image sensor, comprising a third sensing input port and a third sensing output port, and comprising a third clock controller to control an operation clock signal for the third image sensor;
wherein the controller outputs a second command signal and a second synchronizing signal via the second control output port;
wherein the third image sensor receives the second command signal via the third sensing input port to determine if third image data is output by the third sensing output port;
wherein the third clock controller adjusts the operation clock signal for the third image sensor to generate a third adjusted operation clock signal based on the second synchronizing signal received by the third sensing input port;
wherein the third image sensor outputs the third image data to the controller via the third sensing output port based on the third adjusted operation clock signal.

10. The image data sensing system of claim 9, further comprising:
a fourth image sensor, coupled to the third image sensor in series, comprising a fourth sensing input port and a fourth sensing output port, and comprising a fourth clock controller to control an operation clock signal for the fourth image sensor;
wherein the fourth image sensor receives the second command signal via the fourth sensing input port to determine if fourth image data is output by the fourth sensing output port;
wherein the fourth clock controller adjusts the operation clock signal for the fourth image sensor to generate a fourth adjusted operation clock signal based on the second synchronizing signal received by the fourth sensing input port;
wherein the fourth image sensor outputs the fourth image data to the controller via the fourth sensing output port based on the fourth adjusted operation clock signal.

11. The image data sensing system of claim 1, comprising at least one light emitting device, a light emitting device control device configured to control the light emitting device is provided in the first image sensor, wherein the controller does not comprise the light emitting device control device.

12. An image data sensing method, applied to an image data sensing system, wherein the image data sensing system comprises a controller and a first image sensor, wherein the controller comprises a first control input port and a first control output port, wherein the first image sensor comprises a first sensing input port and a first sensing output port, wherein the image data sensing method comprises:
outputting a first command signal and a first synchronizing signal via the first control output port;
receiving the first command signal via the first sensing input port to determine if first image data is output by the first sensing output;
adjusting the operation clock signal for the first image sensor to generate a first adjusted operation clock signal based on the first synchronizing signal received by the first sensing input port; and
applying the first image sensor to output the first image data to the controller via the first sensing output port based on the first adjusted operation clock signal.

13. The image data sensing method of claim 12, further comprising:
determining the first synchronizing signal according to an operation clock signal for the controller.

14. The image data sensing method of claim 12, further comprising:
transmitting the first command signal to the first image sensor only via the first control output port;
transmitting the first synchronizing signal to the first image sensor only via the first control output port; and
transmitting image data to the controller only via the first control input port.

15. The image data sensing method of claim 12, further comprising:
applying the controller to transmit the first command signal and the first synchronizing signal via a time division multiplexing method.

16. The image data sensing method of claim 12, wherein the image data sensing system further comprises a second image sensor, which is coupled to the first image sensor in series and comprises a second sensing input port and a second sensing output port, wherein the image data sensing method comprises:
receiving the first command signal via the second sensing input port to determine if second image data is output by the second sensing output port;
adjusting the operation clock signal for the second image sensor to generate a second adjusted operation clock signal based on the first synchronizing signal received by the second sensing input port; and
applying the second image sensor to output the second image data to the controller via the second sensing output port based on the second adjusted operation clock signal.

17. The image data sensing method of claim 16, further comprising:
applying the controller to transmit an identifying signal to the first image sensor and the second image sensor, for appointing which one or which ones of the first image sensor and the second image sensor should respond image data corresponding to the first command signal.

18. The image data sensing method of claim 17, further comprising:
applying the controller to combine the identifying signal, the command signal and the first synchronizing signal together, and transmitting the identifying signal, the command signal and the first synchronizing signal together via a time division multiplexing method.

19. The image data sensing method of claim 17,
wherein the first image sensor comprises a first memory device;
wherein the second image sensor comprises a second memory device;
wherein the image data sensing method further comprises:
determining when does the first image sensor and the second image sensor operate based on the first command signal according to time information stored in the first memory device and the second memory device.

20. The image data sensing method of claim 12,
wherein the controller further comprises a second control output port;
wherein the image data sensing system further comprises a third image sensor comprising a third sensing input port and a third sensing output port;
wherein the image data sensing method further comprises:
outputting a second command signal and a second synchronizing signal via the second control output port;
receiving the second command signal via the third sensing input port to determine if third image data is output by the third sensing output port;
adjusting the operation clock signal for the third image sensor to generate a third adjusted operation clock signal based on the second synchronizing signal received by the third sensing input port; and
applying the third image sensor to output the third image data to the controller via the third sensing output port based on the third adjusted operation clock signal.

21. The image data sensing method of claim 20, wherein the image data sensing system further comprises a fourth image sensor, which is coupled to the third image sensor in series and comprises a fourth sensing input port and a fourth sensing output port, wherein the image data sensing method comprises:
receiving the second command signal via the fourth sensing input port to determine if fourth image data is output by the fourth sensing output port;
adjusting the operation clock signal for the fourth image sensor to generate a fourth adjusted operation clock signal based on the second synchronizing signal received by the fourth sensing input port; and
applying the fourth image sensor to output the fourth image data to the controller via the fourth sensing output port based on the fourth adjusted operation clock signal.

22. An image data sensing system, comprising:
a controller, comprising a first control input port and a first control output port, and comprising a clock controller to control an operation clock signal for the controller, wherein the controller outputs a first command signal via the first control output port; and
a first image sensor, comprising a first sensing input port and a first sensing output port, wherein the first image sensor receives the first command signal via the first sensing input port and generates first image data;
wherein the first image sensor determines if the first image data is output according to the first command signal;
wherein the first image sensor outputs a first synchronizing signal to the controller via the first sensing output port, wherein the controller receives the first synchronizing signal via the first control input port;
wherein the clock controller adjusts an operation clock signal for the controller according to the first synchronizing signal to generate an adjusted operation clock signal;
wherein the controller receives the first image data via the first control input port based on the adjusted operation clock signal.

23. The image data sensing system of claim 22, wherein the first image sensor determines the first synchronizing signal according to the operation clock signal for the first image sensor.

24. An image data sensing method, applied to an image data sensing system comprising a controller and a first image sensor, wherein the controller comprises a first control input port and a first control output port, wherein the first image sensor comprises a first sensing input port and a first sensing output port, wherein the image data sensing method comprises:
outputting a first command signal via the first control output port;
receiving the first command signal via the first sensing input port and applying the first image sensor to generate first image data according to the first command signal;
applying the first image sensor to determine if the first image data is output according to the first command signal;
outputting a first synchronizing signal to the controller via the first sensing output port, and applying the controller to receive the first synchronizing signal via the first control input port;
adjusting an operation clock signal for the controller according to the first synchronizing signal to generate an adjusted operation clock signal;
applying the controller to receive the first image data via the first control input port based on the adjusted operation clock signal.

25. The image data sensing method of claim 24, further comprising:
applying the first image sensor to determine the first synchronizing signal according to the operation clock signal for the first image sensor.

26. An image data sensing system, comprising:
a controller, comprising a first control input port and a first control output port, configured to output a first command signal via the first control output port;
a first image sensor, comprising a first memory device, a first sensing input port and a first sensing output port, configured to receive the first command signal via the first sensing input port and to output first image data to the controller via the first control input port based on the first command signal; and
a second image sensor, comprising a second memory device, a second sensing input port and a second sensing output port, configured to receive the first command signal via the first sensing input port and to output second image data to the controller via the second control input port based on the first command signal;
wherein the first image sensor and the second image sensor determines when to operate based on the first command signal according to time information stored in the first memory device and the second memory device.

27. The image data sensing system of claim 26,
wherein the controller outputs a first synchronizing signal via the first control output port, wherein the first image sensor comprises a first clock controller and the second image sensor comprises a second clock controller;
wherein the first clock controller adjusts an operation clock signal for the first image sensor to generate a first adjusted operation clock signal based on the first synchronizing signal received by the first sensing input port;
wherein the first image sensor outputs the first image data to the controller via the first sensing output port based on the first adjusted clock signal;
wherein the second clock controller adjusts an operation clock signal for the second image sensor to generate a second adjusted operation clock signal based on the first synchronizing signal received by the second sensing input port;
wherein the second image sensor outputs the second image data to the controller via the second sensing output port based on the second adjusted clock signal.
